(19) United States
(12) Patent Application Publication
(10) Pub. No.: US 2005/0057708 A1
(43) Pub. Date: Mar. 17, 2005

(54) COLOR FILTER STRUCTURE

(76) Inventors: Kuang-Lung Kuo, Chung-Li City (TW); Tzu-Seng Yang, Hsin-Chu Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/711,016

(22) Filed: Aug. 18, 2004

(30) Foreign Application Priority Data
Sep. 15, 2003 (TW) 092125402

(51) Int. Cl. G02F 1/1335

(52) U.S. Cl. 349/106

(57) ABSTRACT

A color filter structure includes a substrate, a light-blocking layer positioned within a rim region on the substrate, and a plurality of conductive color filters positioned on the substrate except the rim region to form a common electrode.

### BACKGROUND OF INVENTION

1. Field of the Invention

The present invention relates to a color filter structure, and more particularly, to a color filter structure employed in a liquid crystal display (LCD).

2. Description of the Prior Art

A color filter structure and thin-film transistor (TFT) elements of a prior art thin-film transistor liquid crystal display (TFT-LCD) are respectively formed on different substrates. The TFT elements are formed in a bottom substrate, named as a TFT substrate, by multiple photo-etching processes (PEP), while the color filter structure is formed on a top substrate, named as a color filter substrate, by photo processes or halftone printing technology. Moreover, the method of forming the prior art LCD includes steps of forming a black matrix on the color filter substrate to prevent light interference between any two adjacent color filters. The purpose of the black matrix is to improve contrast of the LCD, prevent the TFT elements from generating light leakage current, and shade the oblique leaking light during operation of the LCD.

Referring to FIGS. 1 and 2, FIG. 1 is a top view of a color filter substrate according to the prior art, and FIG. 2 is a cross-sectional diagram of the color filter substrate shown in FIG. 1 along the line AA′. As shown in FIGS. 1 and 2, a color filter substrate 10 includes a predetermined region 12 and a rim region 14 surrounding the predetermined region 12. The predetermined region 12 is positioned at a central region of the substrate 10 to be opposite to a pixel region on a TFT substrate (not shown). The predetermined region 12 includes a plurality of light-blocking layers 16a composed of a black matrix, and a plurality of color filters 18, such as red color filters R, green color filters G, and blue color filters B, positioned within the black matrix. Light penetrating through these color filters is capable of generating the original colors of red, green and blue to constitute color images.

The rim region 14 is used to spread a sealant thereon for adhering the color filter substrate to the TFT substrate. Normally, a light-blocking layer 16b is also positioned within the rim region 14 to surround the predetermined region 12, thus preventing light from penetrating through the edge of the substrate to interference with the images of the LCD. In addition, the color filter substrate 10 further includes a transparent conductive layer 20 covering the color filters 18. The transparent conductive layer 20 is used as a common electrode to provide a constant voltage. Using a voltage difference between this constant voltage and another voltage supplied on a pixel electrode positioned on the TFT substrate, a gray level of each pixel of the LCD is capable of being controlled.

In a prior art method of forming the color filter substrate 10, at least four masks are used to define the patterns of the light-blocking layers 16a and 16b, the red color filters R, the green color filters G and the blue color filters B, respectively. Sometimes a fifth mask is needed to define the pattern of the transparent conductive layer 20, or a shadow mask is needed to form the transparent conductive layer 20 and simultaneously define its pattern. In order to decrease the number of the using masks, substitute methods, such as improving the utility of a single mask, using other methods to define the patterns, or forming the transparent conductive layer on the entire substrate without any pattern definition process being performed to define the pattern of the transparent conductive layer, are developed to simplify the manufacturing processes and reduce the production costs. For example, a method is proposed to use a common mask to define the patterns of the red color filters R, the green color filters G, and the blue color filters B, thus improving the utility of the common mask and reducing the production costs. This method uses less masks, however, three photolithographic processes are still needed to define the patterns of the red color filters R, the green color filters G, and the blue color filters B, respectively. It provides no obvious help to simplify the manufacturing processes.

In some cases, photosensitive resin materials are proposed to replace metal materials to form the light-blocking layers 16a and 16b. The patterns of the light-blocking layers 16a, 16b made of the photosensitive resin materials can be defined after the exposing and developing processes. An etching process for defining the patterns as used in the metal materials is thus not required to simplify the manufacturing processes. In other cases, photosensitive resin materials are proposed to form the color filters 18. By controlling the light strength in the exposure process, a particularly pattern composed of the overlapped red color filters R, green color filters G, and blue color filters B cab be obtained. The overlapping region between two adjacent color filters is used as a light-blocking layer, thus achieving the advantages of simplifying the manufacturing processes. However, either using the photosensitive resin materials to form the light-blocking layers or the color filters, a corresponding number of masks are still needed to define the exposure positions on the color filter substrate. It is thus limited to decrease the number of the using masks.

As mentioned above, it is an important issue for the LCD industry to develop a method to effectively decrease the number of the using masks, simplify the manufacturing processes and reduce the production costs.

### SUMMARY OF INVENTION

It is therefore an object of the claimed invention to provide a color filter structure employed in an LCD to solve the above-mentioned problems.

According to the claimed invention, the color filter structure includes a substrate, a light-blocking layer positioned within a rim region on the substrate, and a plurality of conductive color filters positioned on the substrate except the rim region to form a common electrode.

It is an advantage of the present invention that the color filters are made of conductive materials and can be used as the common electrode of the LCD. Therefore, the present invention does not need to form a transparent conductive layer on the substrate and define its pattern to be the common electrode of the LCD. As a result, the advantages of decreasing the number of the using masks, simplifying the manufacturing processes and reducing the production costs can be achieved according to the present invention.

These and other objects of the claimed invention will be apparent to those of ordinary skill in the art after reading the following detailed description of the preferred embodiment that is illustrated in the various figures and drawings.

### BRIEF DESCRIPTION OF DRAWINGS

FIG. 1 is a top view of a color filter substrate according to the prior art;

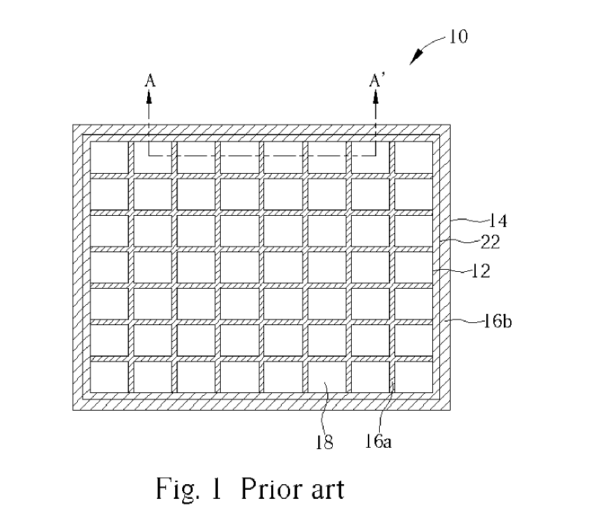

FIG. 2 is a cross-sectional diagram of a color filter substrate according to the prior art;

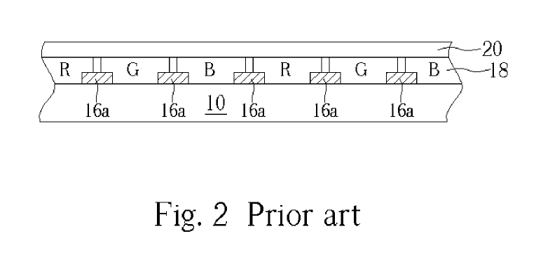

FIG. 3 is a top view of a color filter substrate according to the present invention;

FIG. 4 is a cross-sectional diagram of a color filter substrate according to a first embodiment of the present invention;

FIG. 5 is a cross-sectional diagram of a color filter substrate according to a second embodiment of the present invention; and

FIG. 6 is a cross-sectional diagram of a color filter substrate according to a third embodiment of the present invention.

### DETAILED DESCRIPTION

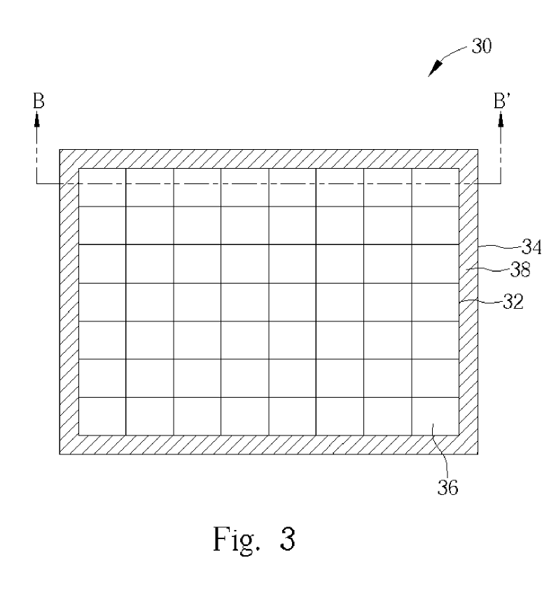

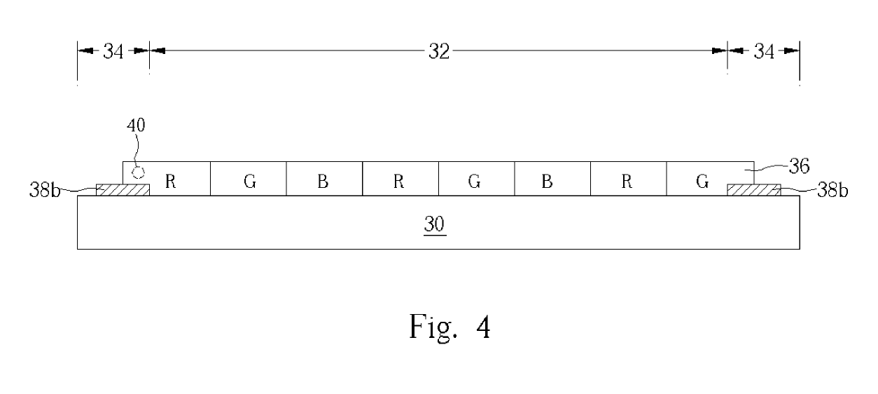

Referring to FIGS. 3 and 4, FIG. 3 is a top view of a color filter substrate according to the present invention, and FIG. 4 is a cross-sectional diagram of the color filter substrate shown in FIG. 3 along the line BB″. As shown in FIGS. 3 and 4, a color filter substrate 30 includes a predetermined region 32 and a rim region 34 surrounding the predetermined region 32. The predetermined region 32 is positioned at a central region of the substrate 30 to be opposite to a pixel region on a TFT substrate (not shown). The predetermined region 32 includes a plurality of color filters 36 made of conductive materials, such as red color filters R, green color filters G, and blue color filters B. Light penetrating through these color filters 36 is capable of generating the original colors of red, green and blue to constitute color images. In addition, any two adjacent color filters 36 within the predetermined region 32 are connected or overlapped with each other, thus forming a conductive layer to replace the conventional transparent conductive layer, such as an indium tin oxide (ITO) layer, to be a common electrode of an LCD.

In a better embodiment of the present invention, each of the color filters 36 is capable of being added with the same conductive materials to have the same potential with the others. For example, the color filters 36 can be doped with conductive macromolecular compounds. Conductive materials having high transmittance for visible light, such as polyethylene dioxythiophene/polystyrene sulfonate (PEDT/PSS, BAYTRON P, BAYER AG) as disclosed in the U.S. Pat. No. 6,083,635 are suggested to dope the color filters 36. In this case, the surface resistance of being less than 300 Ω/□, and the transmittance of being greater than 85% for visible light to penetrate through a 50 nm thick film can be achieved in the doped color filters 36. With these characteristics, the conductive color filters 36 are suitable to replace the transparent conductive materials, such as ITO, to form the common electrode of the LCD. In addition, other conductive materials having minor effects to the optical characteristics of the color filters 36, such as nanometer particles or nanometer metal particles can also be added into the color filters 36 to make the color filters 36 have electric conductivity.

The rim region 34 is used to spread a sealant thereon for adhering the color filter substrate to the TFT substrate. A light-blocking layer 38 is positioned within the rim region 34 to surround the predetermined region 32, thus preventing light from penetrating through the edge of the substrate to interfere with the images of the LCD. The light-blocking layer 38 is made of either conductive materials, such as chromium or its alloy, or insulating materials, such as photosensitive resin materials. When the light-blocking layer 38 is made of conductive materials, the color filters 36 are partially overlapped with the light-blocking layer 38 and use the light-blocking layer 38 to be an interconnection contact pad. When the light-blocking layer 38 is made of insulating materials, the color filters 36 may further include a protrusion structure extending to the rim region 34 and atop the light-blocking layer 38 to be an interconnection contact pad 40, thus enabling a contact plug to be formed on the contact pad 40 to connect the common electrode 36 with other conductive materials.

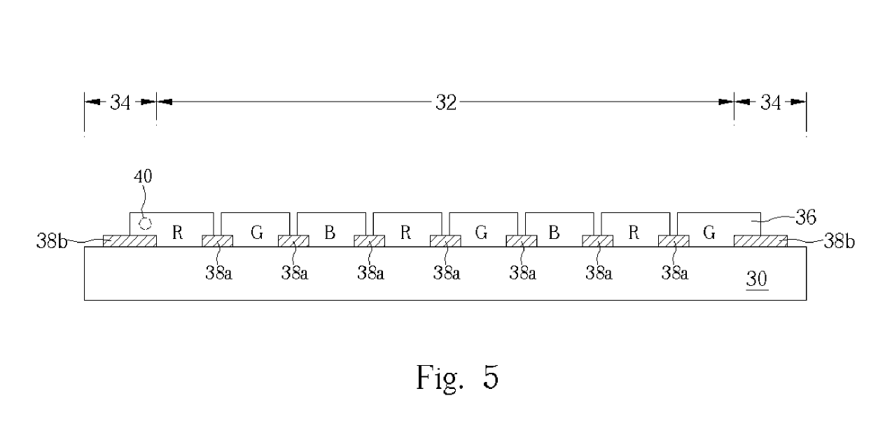

Referring to FIG. 5, FIG. 5 is a cross-sectional diagram of a color filter substrate according to a second embodiment of the present invention. In this embodiment, except a light-blocking layer 38b positioned within the rim region 34, a plurality of light-blocking layers 38a composed of a black matrix are positioned within the predetermined region 32 to prevent light interference between any two adjacent color filters 36. Each of the light-blocking layers 38a is made of conductive materials, and either color filter 36 adjacent to the light-blocking layer 38a is partially overlapped with the light-blocking layer 38a. In this case, the connected color filters 36 and the light-blocking layers 38a form a conductive layer on the color filter substrate 30 to be the common electrode. As for the light-blocking layer 38b positioned within the rim region 34, it is made of either conductive materials or insulating materials.

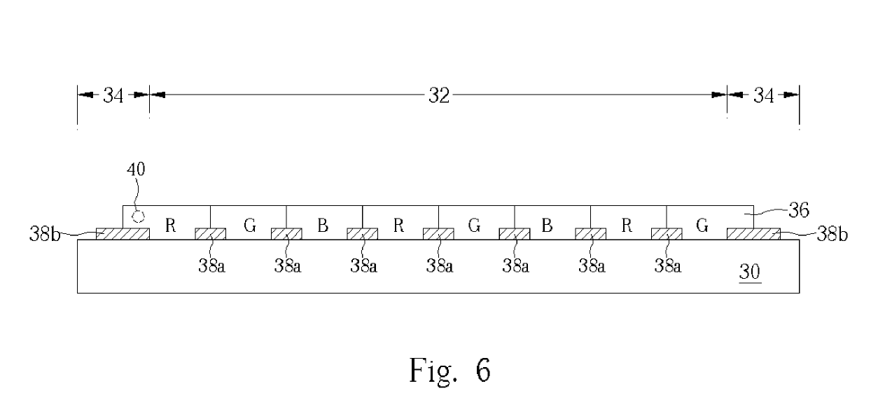

Referring to FIG. 6, FIG. 6 is a cross-sectional diagram of a color filter substrate according to a third embodiment of the present invention. In this embodiment, except a light-blocking layer 38b positioned within the rim region 34, a plurality of light-blocking layers 38a composed of a black matrix are also positioned within the predetermined region 32 to prevent light interference between any two adjacent color filters 36. Each of the light-blocking layers 38a is made of insulating materials, and color filters 36 at either side of the light-blocking layer 38a are connected with each other and partially overlapped with the light-blocking layer 38a. In this case, the connected color filters 36 form a conductive layer on the color filter substrate 30 to be the common electrode. As for the light-blocking layer 38b positioned within the rim region 34, it is made of either conductive materials or insulating materials.

In contrast to the prior art, the color filters of the present invention are made of conductive materials and can be used as the common electrode of the LCD. Therefore, the present invention does not need to form a transparent conductive layer on the substrate and define its pattern to be the common electrode of the LCD. As a result, the advantages of decreasing the number of the using masks, simplifying the manufacturing processes and reducing the production costs can be achieved according to the present invention.

Those skilled in the art will readily observe that numerous modifications and alterations of the device may be made while retaining the teachings of the invention. Accordingly, the above disclosure should be construed as limited only by the metes and bounds of the appended claims.

1. A color filter structure comprising:
a substrate;
a first light-blocking layer positioned within a rim region on the substrate; and
a plurality of conductive color filters positioned on the substrate except the rim region to form a common electrode.

2. The color filter structure of claim 1 wherein the conductive color filters are positioned within a central region on the substrate, the central region being opposite to a pixel region on a thin-film transistor substrate.

3. The color filter structure of claim 1 wherein the conductive color filters comprise at least a red color filter, at least a green color filter and at least a blue color filter.

4. The color filter structure of claim 1 wherein the conductive color filters comprise conductive macromolecular compounds.

5. The color filter structure of claim 1 wherein the conductive color filters comprise conductive nanometer particles.

6. The color filter structure of claim 1 further comprising a plurality of second light-blocking layers positioned on the substrate except the rim region, the second light-blocking layers being used to avoid light interference between two adjacent conductive color filters.

7. The color filter structure of claim 6 wherein the second light-blocking layers are composed of conductive materials, and each of the second light-blocking layer is partially overlapped with its adjacent conductive color filters.

8. The color filter structure of claim 6 wherein the second light-blocking layers are composed of insulating materials, and each of the conductive color filters contacts its adjacent color filter(s).

9. The color filter structure of claim 1 wherein the first light-blocking layer is composed of insulating materials, the conductive color filters comprise a protrusion extending to the rim region and atop the first light-blocking layer, and the protrusion of the conductive color filters is used as an interconnection contact pad.

10. The color filter structure of claim 1 wherein the first light-blocking layer is composed of conductive materials, the conductive color filters are partially overlapped with the first light-blocking layer, and the first light-blocking layer is used as an interconnection contact pad.

11. A color filter structure comprising:
a substrate;
a first light-blocking layer positioned within a rim region on the substrate; and
a plurality of conductive color filters positioned on the substrate, the conductive color filters being partially overlapped with the first light-blocking layer.

12. The color filter structure of claim 11 wherein the conductive color filters comprise at least a red color filter, at least a green color filter and at least a blue color filter.

13. The color filter structure of claim 11 wherein the conductive color filters comprise conductive macromolecular compounds.

14. The color filter structure of claim 11 wherein the conductive color filters comprise conductive nanometer particles.

15. The color filter structure of claim 11 wherein each of the conductive color filters contacts its adjacent conductive color filter(s) to form a common electrode on the substrate.

16. The color filter structure of claim 11 further comprising a plurality of second light-blocking layers positioned on the substrate to avoid light interference between two adjacent conductive color filters.

17. The color filter structure of claim 16 wherein the second light-blocking layers are composed of conductive materials, and each of the second light-blocking layer is partially overlapped with its adjacent conductive color filters.

18. The color filter structure of claim 16 wherein the second light-blocking layers are composed of insulating materials, and each of the conductive color filters contacts its adjacent color filter(s).

19. The color filter structure of claim 11 wherein the first light-blocking layer is composed of insulating materials, the conductive color filters comprise a protrusion extending to atop the first light-blocking layer, and the protrusion of the conductive color filters is used as an interconnection contact pad.

20. The color filter structure of claim 11 wherein the first light-blocking layer is composed of conductive materials and used as an interconnection contact pad.
